(19) United States
(12) Patent Application Publication
(10) Pub. No.: US 2011/0148736 A1
(43) Pub. Date: Jun. 23, 2011

(54) MULTI-INPUT MULTI-OUTPUT ANTENNA FOR IMPROVING ISOLATION

(75) Inventors: Jae-Hoon Choi, Seoul (KR); Jae-Ick Choi, Daejeon (KR); Dong-Ho Kim, Daejeon-si (KR); Hae-II Jung, Seoul (KR); Jung-Pyo Kim, Seoul (KR); Young-Ki Lee, Jeju-si (KR)

(73) Assignee: Electronics and Telecommunications Research Institute, Daejeon-si (KR)

(21) Appl. No.: 12/900,730

(22) Filed: Oct. 8, 2010

(30) Foreign Application Priority Data
Dec. 18, 2009 (KR) 10-2009-0127249

(51) Int. Cl. H01Q 1/52; H01Q 21/00

(52) U.S. Cl. 343/893

(57) ABSTRACT

A multi-input multi-output (MIMO) antenna for improving isolation is provided. Split ring resonators (SRRs) are structurally arranged on the lower end of a ground surface between a plurality of antenna patterns spaced apart from each other. Accordingly, permeability of the SRRs has a negative value, which prevents current from flowing between antennas. Consequently, the isolation characteristic of the antennas is improved.

### CROSS REFERENCE TO RELATED APPLICATION

This application claims the benefit under 35 U.S.C. §119(a) of Korean Patent Application No. 10-2009-0127249, filed on Dec. 18, 2009, in the Korean Intellectual Property Office, the entire disclosure of which is incorporated herein by reference for all purposes.

### BACKGROUND

1. Field

The following description relates to a multi-input multi-output (MIMO) antenna for improving isolation, and more particularly, to technology for preventing mutual interference between a plurality of antennas in a MIMO antenna system in which the antennas are arranged.

2. Description of the Related Art

Since a plurality of antennas are used in a MIMO antenna system, interference may occur between the antennas. Thus, a radiation pattern may be distorted, or mutual coupling between antenna elements may occur.

Meanwhile, to implement a MIMO antenna system in a wireless portable terminal, two or more antenna elements should be disposed in a space smaller than half a wavelength, and thus it is difficult to improve the isolation characteristic.

For this reason, to improve the isolation characteristic, a wall has been built in a three-dimensional structure by installing an isolation improvement device between antennas, a modified ground structure has been used, or a ground wall and connecting line have been added.

### SUMMARY

The following description relates to a multi-input multi-output (MIMO) antenna which causes permeability of split ring resonators (SRRs) to have a negative value using a structural arrangement of the SRRs and thus can prevent current from flowing between antennas and improve the isolation characteristic of the antennas.

In an exemplary embodiment of the present invention, SRRs are structurally arranged on the lower end of a ground surface between a plurality of antenna patterns of an MIMO antenna spaced apart from each other. Thus, permeability of the SRRs has a negative value, which prevents current from flowing between antennas. Consequently, the exemplary embodiment of the present invention can improve the isolation characteristic of the antennas.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a perspective view of a multi-input multi-output (MIMO) antenna for improving isolation according to an exemplary embodiment of the present invention.

FIG. 2 is an assembly perspective view of the MIMO antenna for improving isolation shown in FIG. 1.

FIG. 3 is a perspective view of a split ring resonator (SRR) according to an exemplary embodiment of the present invention.

FIG. 4 is a graph showing a scattering (S)-parameter characteristic according to whether or not an SRR is present.

FIGS. 5 and 6 show radiation patterns of respective antennas according to whether or not an SRR is present.

FIG. 7 is a graph showing an S-parameter characteristic according to the length of an SRR.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

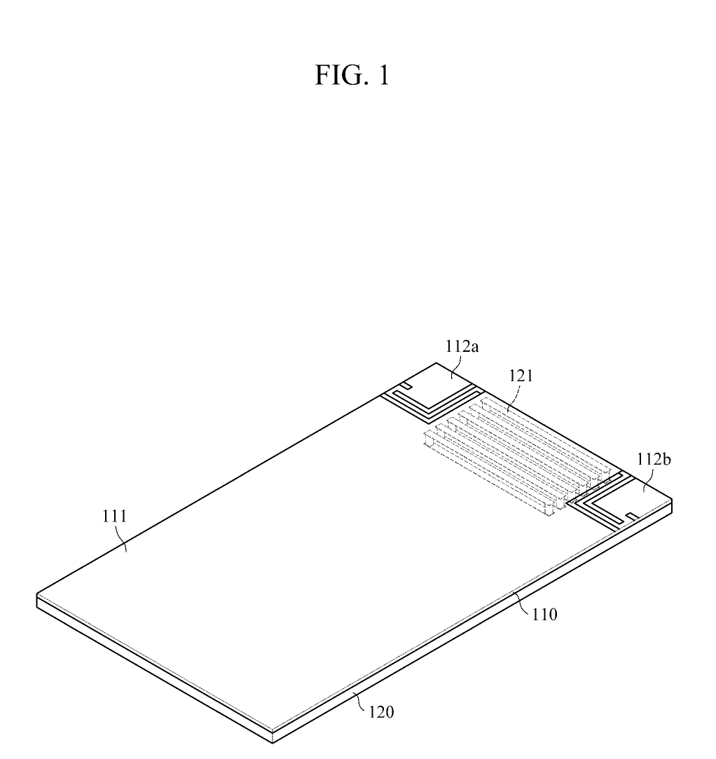

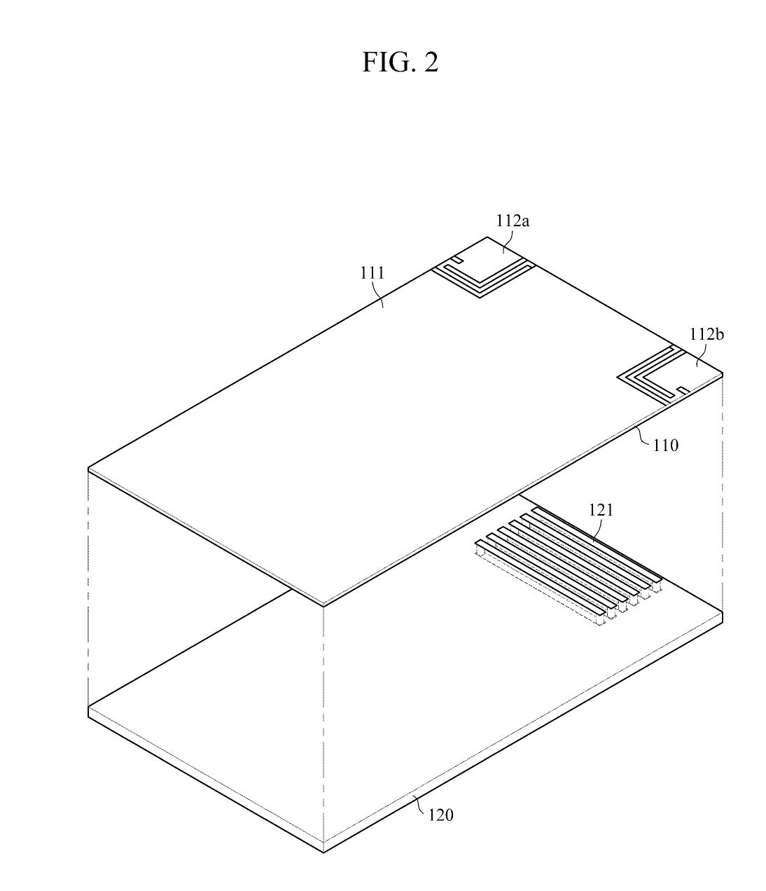

FIG. 1 is a perspective view of a multi-input multi-output (MIMO) antenna for improving isolation according to an exemplary embodiment of the present invention. FIG. 2 is an assembly perspective view of the MIMO antenna for improving isolation shown in FIG. 1. As shown in FIGS. 1 and 2, a MIMO antenna for improving isolation according to this exemplary embodiment includes a first substrate 110 and a second substrate 120.

The first substrate 110 includes a ground surface 111 and a plurality of antenna patterns 112a and 112b spaced apart from each other. The antenna patterns 112a and 112b can be patterned in various shapes on the first substrate 110 according to a resonant frequency characteristic of an implemented antenna.

The second substrate 120 includes a split ring resonator (SRR) 121 formed to be disposed on the lower end of the ground surface 111 between the antenna patterns 112a and 112b. Here, the SRR 121 may be plural in number and arranged at intervals on the second substrate 120.

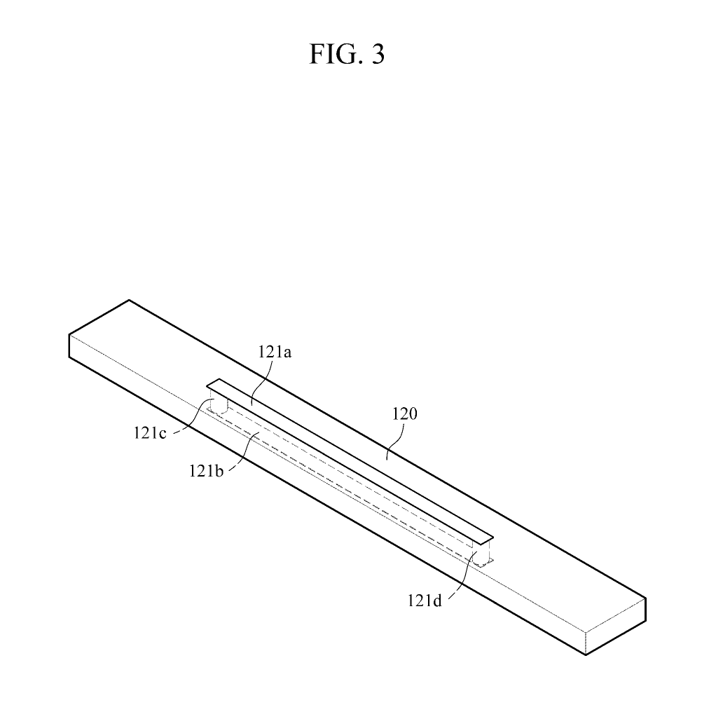

FIG. 3 is a perspective view of an SRR according to an exemplary embodiment of the present invention. As shown in FIG. 3, the SRR 121 may include microstrip lines 121a and 121b respectively printed on the both surfaces of the second substrate 120, and a plurality of vias 121c and 121d connecting the two microstrip lines 121a and 121b at the both ends of the two microstrip lines 121a and 121b.

When the plurality of SRRs 121 are arranged at intervals on the second substrate 120, the SRRs 121 have negative permeability, and current does not flow between antennas, so that the isolation characteristic between the antennas is improved.

To be specific, current is induced in the SRRs 121 by an external magnetic field, and thus the SRRs 121 have a magnetic moment. As a result, the permeability of the SRRs 121 varies.

When the permeability of the SRRs 121 has a negative value due to the structure in which the plurality of SRRs 121 are arranged at regular intervals as shown in FIGS. 1 and 2, current does not flow between the antennas, and the isolation characteristic between the antennas is improved.

The permeability (μ) is defined as the ratio of magnetic flux density (B) of a magnetic substance placed in a magnetic field to magnetic field strength (H). This is expressed by the following equation:

μ=B/H

Since the magnetic field strength (H) is proportional to induced current, current does not flow when the permeability (μ) has a negative value.

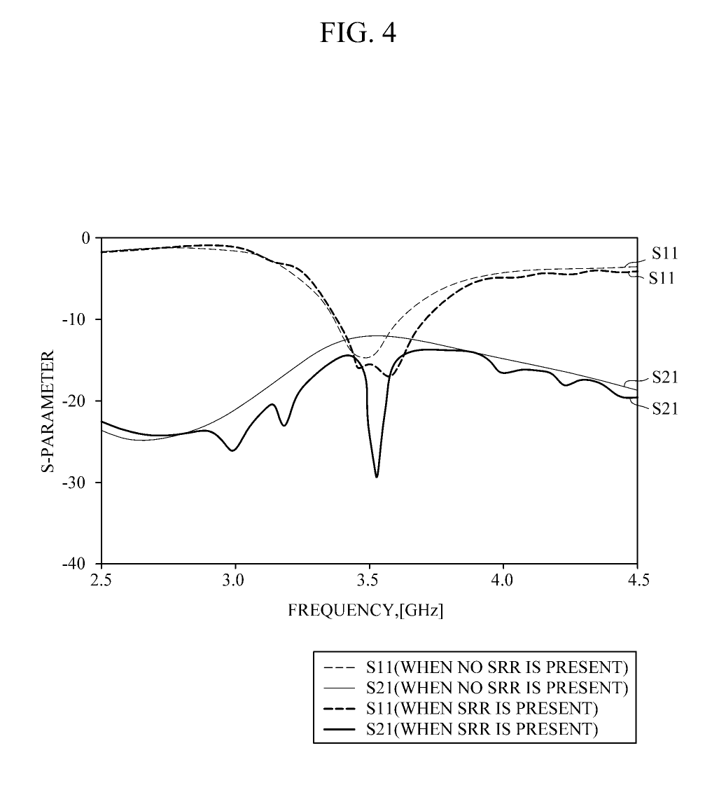

FIG. 4 is a graph showing a scattering (S)-parameter characteristic according to whether or not an SRR is present. An S-parameter denotes an input voltage-to-output voltage ratio according to frequency. S11 corresponds to a case in which an input port is the same as an output port, and denotes a ratio of voltage input to a first port to voltage output from the first port. In other words, S11 denotes a return value obtained by inputting voltage to a port and receiving voltage from the same port, that is, a reflected value, and thus it is possible to know a resonant frequency characteristic from S11.

S21 corresponds to a case in which an input port differs from an output port, and denotes a ratio of voltage input to a first port to voltage output from a second port. Since power input to the first port is output from the second port, S21 denotes a transmitted value. Thus, it is possible to know an isolation characteristic from S21.

In FIG. 4, respective dotted lines S11 denote s-parameter characteristics according to whether or not an SRR is present, and respective solid lines S21 denote isolation characteristics according to whether or not an SRR is present. When no SRR is present, S21 has an isolation of −12 dB. On the other hand, when an SRR is present, S21 has an isolation of −30 dB, that is, the isolation characteristic is improved.

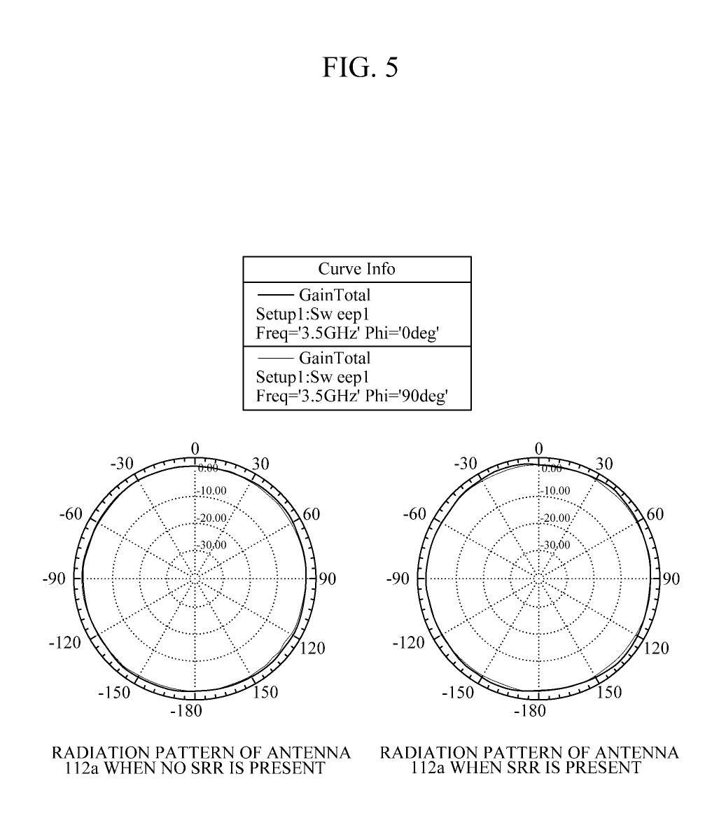

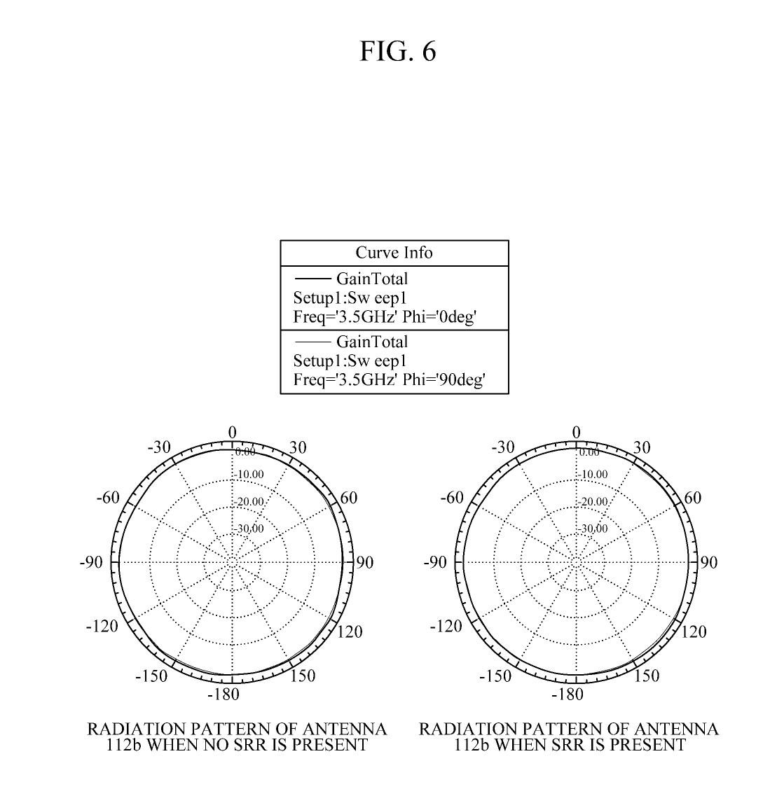

FIGS. 5 and 6 show radiation patterns of the respective antennas 112a and 112b according to whether or not an SRR is present. As shown in FIGS. 5 and 6, gains and radiation patterns of the antennas 112a and 112b are scarcely affected by the presence of an SRR.

Meanwhile, in an additional aspect of the present invention, a MIMO antenna for improving isolation according to an exemplary embodiment of the present invention can adjust a cut-off frequency band according to the length of an SRR. At this time, the longer the SRR, the lower frequency band the cut-off frequency band moves to.

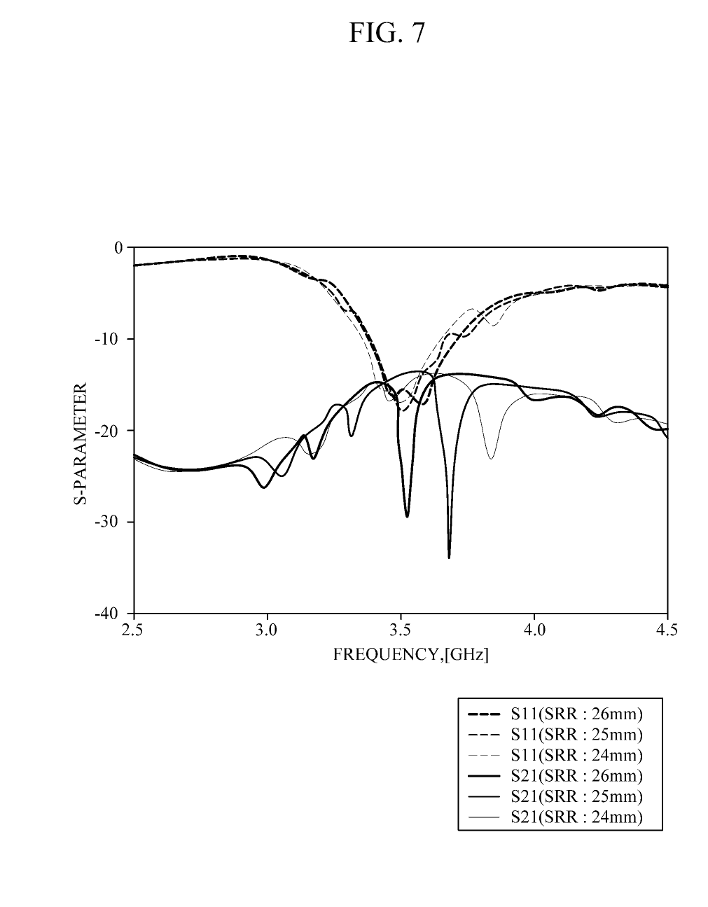

FIG. 7 is a graph showing an S-parameter characteristic according to the length of an SRR. As shown in FIG. 7, even if the length of an SRR varies, S11, that is, the resonant frequency of an antenna, does not vary. On the other hand, a frequency band cut off by the SRR moves to a low frequency band as the length of SRR increases. The S-parameter characteristics and radiation patterns of FIGS. 4 to 7 are results of measurement on a MIMO antenna operating in a band from 3.4 GHz to 3.6 GHz.

As apparent from the above description, in an exemplary embodiment of the present invention, SRRs are structurally arranged on the lower end of a ground surface between a plurality of antenna patterns spaced apart from each other. Thus, permeability of the SRRs has a negative value, and current flow is prevented. Consequently, the isolation characteristic can be improved, thereby achieving the above-mentioned purpose of the present invention.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

An exemplary embodiment of the present invention can be industrially used in a technical field for improving the isolation of an antenna and application technical fields thereof.

What is claimed is:

1. A multi-input multi-output (MIMO) antenna for improving isolation, comprising:
a first substrate including a ground surface and a plurality of antenna patterns spaced apart from each other; and
a second substrate including a split ring resonator (SRR) formed to be disposed on a lower end of the ground surface between the antenna patterns.

2. The MIMO antenna of claim 1, wherein the SRR is plural in number and arranged at intervals on the second substrate.

3. The MIMO antenna of claim 1, wherein a cut-off frequency band is adjusted according to a length of the SRR.

4. The MIMO antenna of claim 3, wherein the cut-off frequency band moves to a lower frequency band as the length of the SRR increases.

5. The MIMO antenna of claim 1, wherein the SRR includes:
microstrip lines respectively printed on both surfaces of the second substrate; and
a plurality of vias configured to connect the two microstrip lines at both ends of the microstrip lines.
